(19) United States
(12) Patent Application Publication
(10) Pub. No.: US 2022/0410894 A1
(43) Pub. Date: Dec. 29, 2022

(54) SYSTEMS AND METHODS FOR OPERATING AN AUTONOMOUS VEHICLE

(71) Applicant: TUSIMPLE, INC., San Diego, CA (US)

(72) Inventors: Scott Douglas FOSTER, San Diego, CA (US); Neil M. OVERMON, Redwood City, CA (US); Erik Orlando PORTILLO, Sterling, VA (US); Zhujia SHI, San Diego, CA (US); Joyce TAM, Pleasanton, CA (US)

(21) Appl. No.: 17/809,543

(22) Filed: Jun. 28, 2022

Related U.S. Application Data
(60) Provisional application No. 63/216,357, filed on Jun. 29, 2021.
(60) Provisional application No. 63/216,358, filed on Jun. 29, 2021.

(51) Int. Cl. B60W 30/14; B60W 60/00; B60W 40/06; B60W 40/10; B60W 30/18

(52) U.S. Cl. CPC B60W 30/146; B60W 60/0015; B60W 40/06; B60W 40/10; B60W 30/18109; B60W 2552/00; B60W 2555/60; B60W 2520/00

(57) ABSTRACT

An autonomous vehicle (AV) includes features that allows the AV to comply with applicable regulations and statues for performing safe driving operation. An example method for operating an AV includes receiving, from a sensor located on the AV, sensor data that captures a road sign located at a distance from the AV that is operating on a roadway; obtaining, from the sensor data, roadway information indicated by the road sign that corresponds to a segment of the roadway associated with the road sign that is ahead of a current position of the AV on the roadway; determining trajectory-related information for the AV for the distance that is based on the roadway information obtained from the sensor data; and causing the AV to travel in accordance with the trajectory-related information until a determination that the AV has arrived within the segment of the roadway associated with the road sign.

### PRIORITY CLAIMS AND RELATED PATENT APPLICATIONS

This patent document claims the priority to and the benefits of U.S. Provisional Application No. 63/216,357 entitled “SYSTEM AND METHOD FOR AN AUTONOMOUS VEHICLE” filed on Jun. 29, 2021, and U.S. Provisional Application No. 63/216,358 entitled “SYSTEM AND METHOD FOR AN AUTONOMOUS VEHICLE” filed on Jun. 29, 2021. The entire disclosures of the aforementioned applications are hereby incorporated by reference as part of the disclosure of this application.

### TECHNICAL FIELD

The present disclosure relates generally to autonomous vehicles. More particularly, the present disclosure is related to operating an autonomous vehicle (AV) appropriately on public roads, highways, and locations with other vehicles or pedestrians.

### BACKGROUND

Autonomous vehicle technologies can provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY

Systems and methods are described herein that can allow an autonomous vehicle (AV) to navigate from a first point to a second point. In some embodiments, the AV can navigate from the first point to the second point without a human driver present in the AV and to comply with instructions for safe and lawful operation.

In one exemplary aspect, a method for operating an autonomous vehicle is described. The method includes receiving, from a sensor located on the autonomous vehicle, sensor data that captures a road sign located at a distance from the autonomous vehicle that is operating on a roadway; obtaining, from the sensor data, roadway information indicated by the road sign, wherein the roadway information corresponds to a segment of the roadway associated with the road sign, and wherein the segment is ahead of a current position of the autonomous vehicle on the roadway; determining a first trajectory-related information for the autonomous vehicle for the distance, wherein the first trajectory-related information is based on the roadway information obtained from the sensor data; and causing the autonomous vehicle to travel in accordance with the first trajectory-related information until a determination that the autonomous vehicle has arrived within the segment of the roadway associated with the road sign.

In yet another exemplary aspect, a system for operating an autonomous vehicle, comprising a computer that includes a processor configured to perform the above-described methods and the method described in this patent document.

In yet another exemplary aspect, the above-described methods and the methods described in this patent document are embodied in a non-transitory computer readable storage medium. The non-transitory computer readable storage medium includes code that when executed by a processor, causes the processor to perform the methods described in this patent document.

In another exemplary embodiment, a device that is configured or operable to perform the above-described methods is disclosed. In yet another exemplary embodiment, a system comprises a computer located in a vehicle, the computer comprises a processor configured to implement the above-described methods is disclosed.

The above and other aspects and their implementations are described in greater detail in the drawings, the descriptions, and the claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates a block diagram of an example vehicle ecosystem of an autonomous vehicle.

FIG. 2 shows a flow diagram for safe operation of an autonomous vehicle safely in light of the health and/or surroundings of the autonomous vehicle.

FIG. 3 illustrates a system that includes one or more autonomous vehicles, a control center or oversight system with a human operator (e.g., a remote center operator (RCO)), and an interface for third-party interaction.

FIG. 4 shows an exemplary block diagram of a remote computer associated with an oversight system.

FIGS. 5A and 5B illustrate example road signs that may be detected by an autonomous vehicle.

FIG. 6 illustrates an example road sign that may be detected by an autonomous vehicle.

FIG. 7 illustrates an example road sign that may be detected by an autonomous vehicle.

FIGS. 8A, 8B, and 8C illustrate example road signs that may be detected by an autonomous vehicle.

FIG. 9 shows a diagram illustrating an example configuration of a portion of a roadway on which an autonomous vehicle may operate.

FIG. 10 shows an example flowchart of example operations for operating an autonomous vehicle using roadway information obtained from detected road signs.

FIG. 11 shows a diagram that demonstrates example embodiments of the present disclosure, including those related to determining trajectories based on road signs.

### DETAILED DESCRIPTION

Vehicles traversing highways and roadways are legally required to comply with regulations and statues in the course of safe operation of the vehicle. For autonomous vehicles (AVs), particularly autonomous tractor trailers, the ability to recognize a malfunction in its systems and stop safely can allow for a lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

This patent document describes in Section I below an example vehicle ecosystem of an autonomous vehicle and driving related operations of the autonomous vehicle. Section II describes a control center or oversight system for one or more autonomous vehicles, as well as various example features thereof and operations/processes performed thereby. Sections III to VI describe operations performed by the autonomous vehicle in various scenarios. The example headings for the various sections below are used to facilitate the understanding of the disclosed subject matter and do not limit the scope of the claimed subject matter in any way. Accordingly, one or more features of one example section can be combined with one or more features of another example section.

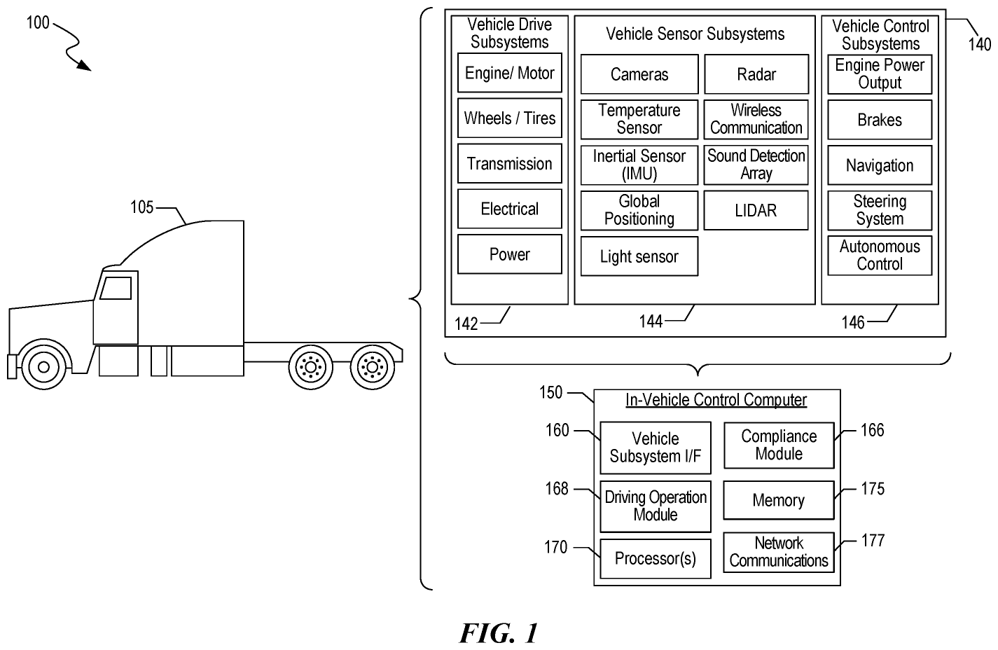

This patent document uses many abbreviations and uncommon terms. For instance, “GNSS” or “GPS” may refer to satellite navigation systems; when referring to an emergency vehicle, such as a police vehicle, ambulance, fire truck, tow truck, and the like, the abbreviation “EV” may be used; the acronym “TTC” indicates “time to collision”; “NPC” refers to non-player characters and may include any other vehicle that is not the autonomous vehicle in FIG. 1. For example, any surrounding vehicle, motorcycle, bicycle, and the like that are manually driven or autonomously driven and that may not be in communication with the autonomous vehicle may be considered NPC; a “k-ramp” denotes a freeway on/off ramp of a particular configuration; “STV” indicates a stopped vehicle; “ELV” may indicate an end-of-life or disabled vehicle, such as a disabled vehicle on a roadside; “OBO” may refer to an on-board operator or a human operator of an autonomous vehicle who temporarily takes control to assist during inspections, start-up, and/or ending of a trip or mission for the autonomous vehicle; and “LC” may be an abbreviation for lane change.

### I. Example Ecosystem of an Autonomous Vehicle

FIG. 1 shows a system 100 that includes an autonomous vehicle 105. The autonomous vehicle 105 may include a tractor of a semi-trailer truck. The autonomous vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the autonomous vehicle 105 moves. The autonomous vehicle 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous vehicle 105, including those which would indicate a malfunction in the autonomous vehicle or another cause for an autonomous vehicle to perform a limited or minimal risk condition (MRC) maneuver or an emergency driving maneuver. A driving operation module (shown as 168 in FIG. 1) can perform an MRC maneuver by sending instructions that cause the autonomous vehicle to steer along a trajectory to a side of the road and to apply brakes so that the autonomous vehicle can be safely stopped to the side of the road. The sensors for general operation of the autonomous vehicle may include cameras, a temperature sensor, an inertial sensor (IMU), a global positioning system, a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous vehicle 105. Microphones used may be any suitable type, mounted such that they are effective both when the autonomous vehicle 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more pre-determined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (e.g., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow an autonomous vehicle to communicate with surrounding drivers or signal surrounding vehicles or drivers for safe operation of the autonomous vehicle.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous vehicle 105 in response to information from the various vehicle subsystems 140. The one or more processors 170 execute the operations that allow the system to determine the health of the autonomous vehicle, such as whether the autonomous vehicle has a malfunction or has encountered a situation requiring service or a deviation from normal operation and giving instructions. Data from the vehicle sensor subsystems 144 is provided to VCU 150 so that the determination of the status of the autonomous vehicle can be made. The compliance module 166 determines what action should be taken by the autonomous vehicle 105 to operate according to the applicable (e.g., local) regulations. Data from other vehicle sensor subsystems 144 may be provided to the compliance module 166 so that the best course of action in light of the autonomous vehicle's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. For example, compliance module 166 and/or the driving operation module 168 in the VCU 150 may send instructions to one or more devices of the autonomous vehicle 105. The one or more devices may include one or more devices in the vehicle drive subsystems 142, the vehicle sensor subsystems 144, or the vehicle control subsystems 146. These instructions sent by the VCU 150 to one or more devices in the autonomous vehicle 105 are configured to effectuate and result in certain operations and actions being performed by the one or more devices in accordance with the instructions. Operations resulting from the instructions being sent to the one or more devices may together form driving related operations performed by the autonomous vehicle 105. For example, the VCU 150 may send instructions to a motor in the steering system, to an actuator in a brake unit, an/or to the engine to cause one or more devices to operate in accordance with the instructions such that the autonomous vehicle 105 performs a maneuver, or steers to follow a trajectory at a specified (e.g., via the instructions) velocity and/or acceleration/deceleration. Thus, the instructions provided by the VCU 150 can allow the autonomous vehicle 105 to follow a trajectory to steer from a current lane on which the autonomous vehicle 105 is operating to an adjacent lane or to a shoulder area (e.g., emergency stopping lane or area on side of the roadway) on the roadway. The autonomous control vehicle control subsystem may receive a course of action to be taken from the compliance module 166 of the VCU 150 and consequently relay instructions to other subsystems to execute the course of action. In Sections III to VI below, this patent document describes that the autonomous vehicle or a system performs certain functions or operations. These functions and/or the operations described can be performed by the compliance module 166 and/or the driving operation module 168.

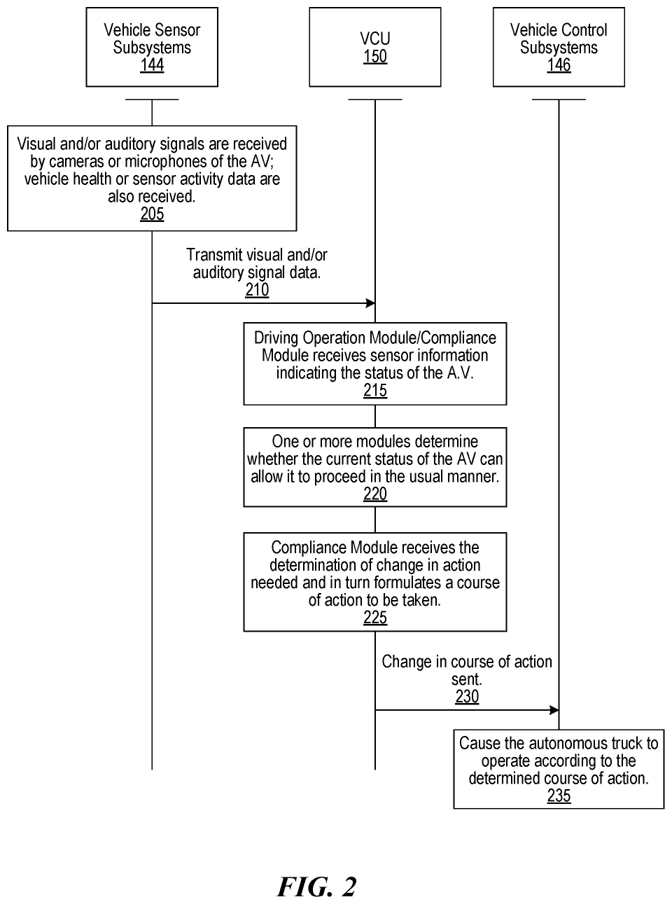

FIG. 2 shows a flow diagram for safe operation of an autonomous vehicle (AV) safely in light of the health and/or surroundings of the autonomous vehicle. Although this figure depicts functional steps in a particular order for purposes of illustration, the process is not limited to any particular order or arrangement of steps. One skilled in the relevant art will appreciate that the various steps portrayed in this figure may be omitted, rearranged, combined and/or adapted in various ways.

As shown in FIG. 2, the vehicle sensor subsystem 144 receives visual, auditory, or both visual and auditory signals indicating the at the environmental condition of the autonomous vehicle, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the autonomous vehicle can allow it to proceed in the usual manner or that the autonomous vehicle needs to alter its course to prevent damage or injury or to allow for service in step 220. The information indicating that a change to the course of the autonomous vehicle is needed may include an indicator of sensor malfunction; an indicator of a malfunction in the engine, brakes, or other components that may be necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the autonomous vehicle's course of action or driving related operation is needed may be used by the compliance module to formulate a new course of action to be taken which accounts for the autonomous vehicle's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

### II. Autonomous Vehicle Oversight System

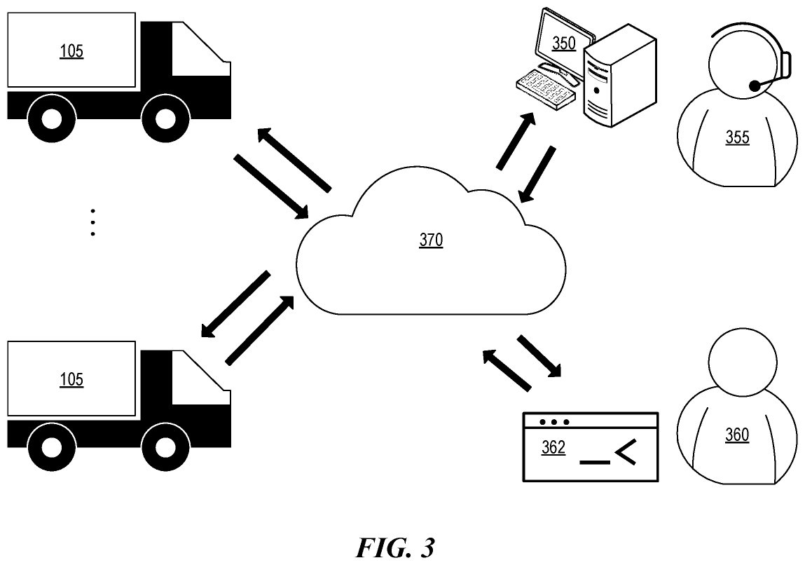

FIG. 3 illustrates a system 300 that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous truck may be in communication with an oversight system. The oversight system may serve many purposes, including: tracking the progress of one or more autonomous vehicles (e.g., an autonomous truck); tracking the progress of a fleet of autonomous vehicles; sending maneuvering instructions to one or more autonomous vehicles; monitoring the health of the autonomous vehicle(s); monitoring the status of the cargo of each autonomous vehicle in contact with the oversight system; facilitate communications between third parties (e.g., law enforcement, clients whose cargo is being carried) and each, or a specific, autonomous vehicle; allow for tracking of specific autonomous trucks in communication with the oversight system (e.g., third-party tracking of a subset of vehicles in a fleet); arranging maintenance service for the autonomous vehicles (e.g., oil changing, fueling, maintaining the levels of other fluids); alerting an affected autonomous vehicle of changes in traffic or weather that may adversely impact a route or delivery plan; pushing over the air updates to autonomous trucks to keep all components up to date; and other purposes or functions that improve the safety for the autonomous vehicle, its cargo, and its surroundings. An oversight system may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle's progress during the maneuver; when to hand over control of the autonomous vehicle to a human driver (e.g., at a destination yard); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and the like.

Included in some of the functions executed by an oversight system or command center is the ability to relay over-the-air, real-time weather updates to autonomous vehicles in a monitored fleet. The over-the-air weather updates may be pushed to all autonomous vehicles in the fleet or may be pushed only to autonomous vehicles currently on a mission to deliver a cargo. Alternatively, or additionally, priority to push or transmit over-the-air weather reports may be given to fleet vehicles currently on a trajectory or route that leads towards or within a pre-determined radius of a severe weather event.

Another function that may be encompassed by the functions executed by an oversight system or command center is the transmission of trailer metadata to the autonomous vehicle's computing unit (VCU) prior to the start of a cargo transport mission. The trailer metadata may include the type of cargo being transmitted, the weight of the cargo, temperature thresholds for the cargo (e.g., trailer interior temperature should not fall below or rise above pre-determined temperatures), time-sensitivities, acceleration/deceleration sensitivities (e.g., jerking motion may be bad because of the fragility of the cargo), trailer weight distribution along the length of the trailer, cargo packing or stacking within the trailer, and the like.

An oversight system or command center may be operated by one or more human, also known as an operator or a remote center operator (RCO). The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the oversight system or by the operator may receive instructions that are automatically sent from the oversight system to perform the precautionary action.

The operator may be made aware of situations affecting one or more autonomous vehicles in communication with or being monitored by the oversight system that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the oversight system operator through traffic reports, law enforcement communications, data from other vehicles that are in communication with the oversight system, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the oversight system may push such information to affected autonomous vehicles that are in communication with the oversight system. The affected autonomous vehicles may proceed to alter their route, trajectory, or speed in response to the information pushed from the oversight system. In some instances, the information received by the oversight system may trigger a threshold condition indicating that MRC (minimal risk condition) maneuvers are warranted; alternatively, or additionally, an operator may evaluate a situation and determine that an affected autonomous vehicle should perform an MRC maneuver and subsequently send such instructions to the affected vehicle. In these cases, each autonomous vehicle receiving either information or instructions from the oversight system or the oversight system operator uses its on-board computing unit (e.g. VCU) to determine how to safely proceed, including performing an MRC maneuver that includes pulling-over or stopping.

Other interactions that the remote center operator (RCO) may have with an autonomous vehicle or a fleet of autonomous vehicle includes any of the following: pre-planned event avoidance; real-time route information updates; real-time route feedback; trail hookup status; first responder communication request handling; notification of aggressive surrounding vehicle(s); identification of construction zone changes; status of an autonomous vehicle with respect to its operational design domain (ODD), such as alerting the RCO when an autonomous vehicle is close to or enters a status out of ODD; RCO notification of when an autonomous vehicle is within a threshold distance from a toll booth and appropriate instruction/communication with the autonomous vehicle or toll authority may be sent to allow the autonomous vehicle to bypass the toll; RCO notification of when an autonomous vehicle bypasses a toll; RCO notification of when an autonomous vehicle is within a threshold distance from a weigh station and appropriate instruction/communication with the autonomous vehicle or appropriate authority may be sent to allow the autonomous vehicle to bypass the weigh station; RCO notification of when an autonomous vehicle bypasses a weigh station; notification to the autonomous vehicle from the RCO regarding scheduling or the need for fueling or maintenance; RCO authorization of third-party access to an autonomous vehicle cab; ability of an RCO to start/restart an autonomous driving system (ADS) on a vehicle; ability of an administrator (possibly an RCO) to set roles for system users, including ground crew, law enforcement, and third parties (e.g., customers, owners of the cargo); support from a RCO for communication with a service maintenance system with fleet vehicles; notification to the RCO from an autonomous vehicle of acceleration events; instruction from a RCO to an autonomous vehicle to continue its mission even when communication is interrupted; RCO monitoring of an autonomous vehicle during and after an MRC maneuver is executed; support for continuous communication between an autonomous vehicle and a yard operator at facility where the autonomous vehicle is preparing to begin a mission or where the autonomous vehicle is expected to arrive; oversight system monitoring of software systems on an autonomous vehicle and oversight system receiving alerts when software systems are compromised; and the like.

An oversight system or command center may allow a third party to interact with the oversight system operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the oversight system may recognize different levels of access, such that a customer concerned about the timing or progress of a shipment may only be allowed to view status updates for an autonomous truck, or may able to view status and provide input regarding what parameters to prioritize (e.g., speed, economy, maintaining originally planned route) to the oversight system. By providing input regarding parameter prioritization to the oversight system, a customer can influence the route and/or operating parameters of the autonomous truck.

Actions that an autonomous vehicle, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the truck, in that these actions may be executable programming stored on the VCU 150 (the in-vehicle control computer unit). These actions or features may include those related to reactions to the detection of certain types of conditions or objects such as: appropriate motion on hills; appropriate motion on curved roads, appropriate motion at highway exits; appropriate motion or action in response to: detecting of one or more stopped vehicle, detecting one or more vehicles in an emergency lane; detecting an emergency vehicle with flashing lights that may be approaching the autonomous vehicle; motion in response to detecting on or more large vehicles approaching, adjacent to, or soon, to be adjacent to the autonomous vehicle; motions or actions in response to pedestrians, bicyclists, and the like after identification and classification of such actors; motions or actions in response to curved or banked portions of the roadway; and/or motions in response to identifying on and off ramps on highways or freeways, encountering an intersection; execution of a merge into traffic in an adjacent lane or area of traffic; detection of need to clean one or more sensor and the cleaning of the appropriate sensor; identification of law enforcement/emergency vehicles and personnel and compliance with associated instructions or regulations; execution of minimal risk condition maneuvers when needed; and identification of road debris or unknown objects; and the like. Other features of an autonomous truck may include those actions or features which are needed for any type of maneuvering, including that needed to accomplish the features or actions that are reactionary, listed above.

Supporting features may include: changing lanes safely; operating turn signals on the autonomous truck to alert other drivers of intended changes in motion; biasing the autonomous truck in its lane (e.g., moving away from the center of the lane to accommodate the motions or sizes of neighboring vehicles or close objects); ability to maintain an appropriate following distance; the ability to turn right and left with appropriate signaling and motion, and the like. Supporting features may also include: the ability to navigate roundabouts; the ability to properly illuminate with on-vehicle lights as-needed for ambient light and for compliance with local laws; apply the minimum amount of deceleration needed for any given action; determine location at all times; adapting dynamic vehicle control for trailer load distributions, excluding wheel adjustment; launching (reaching target speed), accelerating, stopping, and yielding; operate on roadways with bumps and potholes; enter a minimal risk condition (MRC) on roadway shoulders; access local laws and regulations based on location along a route; operate on asphalt, concrete, mixed grading, scraped road, and gravel; ability to operate in response to metering lights/signals at on-ramps; operate on a roadway with a width up to a pre-determined width; able to stop at crosswalks with sufficient stopping distance; navigate two-way left turn lanes; operate on roadways with entry and exit ramps; utilize the vehicle horn to communicate with other drivers; and the like. One or more features and/or one or more supporting features described in this patent document may combined and can be performed by the in-vehicle control computer in an autonomous truck.

In some embodiments, the actions or features may be considered supporting features and may include: speed control; the ability to maintain a straight path; and the like. These supporting features, as well as the reactionary features listed above, may include controlling or altering the steering, engine power output, brakes, or other vehicle control subsystems 146. The reactionary features and supporting features listed above are discussed in greater detail below.

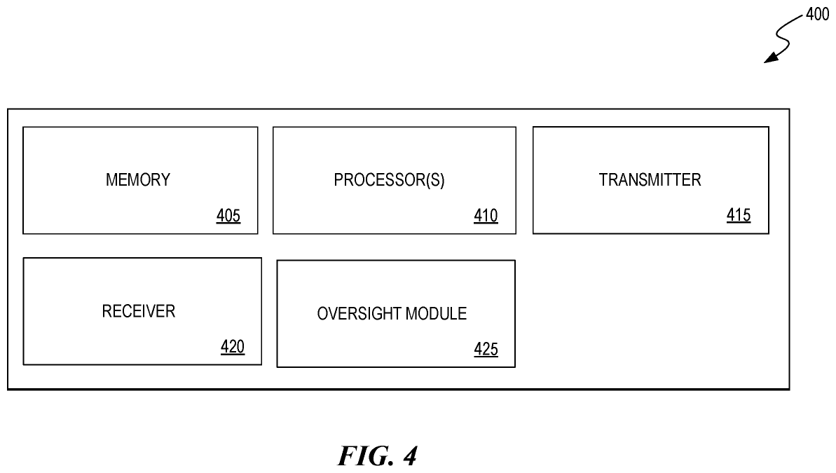

FIG. 4 shows an exemplary block diagram of a remote computer 400 associated with an oversight system. The oversight system (shown as 350 in FIG. 3) may include the remote computer 400 which can be located at a fixed location outside of an autonomous vehicle. In this patent document, the descriptions related to operations performed by the oversight system can be performed by the oversight module (shown as 425 in FIG. 7) in the remote computer 400. The remote computer 400 includes at least one processor 410 and a memory 405 having instructions stored thereupon. The instructions, upon execution by the processor 410, configure the remote computer 400 to perform the operations related to the oversight module 425, where the oversight module 425 can perform operations related to the oversight system as described at least in FIGS. 1 to 3 and in the various embodiments described in this patent document. A remote computer 400 may include one or more servers. The transmitter 415 transmits or sends information or data to one or more autonomous vehicles, and the receiver 420 receives information or data from one or more autonomous vehicles.

### III. Speed Control

According to various embodiments, an autonomous vehicle may be operated according to determined speeds to ensure safe and compliant operation of the autonomous vehicle. In some embodiments, speeds for the autonomous vehicle may be determined based on roadway conditions, roadway characteristics, and regulations controlling a roadway on which the autonomous vehicle is operating. In some examples, speeds for the autonomous vehicle, along with other trajectory-related information, may be determined based on regulation and other roadway information indicated by road signs located along the roadway that are detected by the autonomous vehicle. For example, the autonomous vehicle may detect various road signs as the autonomous vehicle travels along a roadway using various sensors including cameras, LiDAR sensors, or the like.

III.(a) Speed Control—Obey Speed Limits

At all times, an autonomous vehicle may drive at or below the posted speed limit. In some embodiments, a speed of the autonomous vehicle may be determined to satisfy or comply with the posted speed limit if the speed is at or below the posted speed limit. In some embodiments, a speed of the autonomous vehicle may be determined to satisfy or comply with the posted speed limit if the speed is below the posted speed limit within a predetermined threshold (e.g. 5 miles per hour under the posted speed limit, 10 miles per hour under the posted speed limit, 20 miles per hour under the posted speed limit). In some embodiments, a speed of the autonomous vehicle may be determined to satisfy or comply with the posted speed limit if the speed is within a predetermined threshold above or below the posted speed limit (e.g., 5 miles per hour above or below the posted speed limit, 10 miles per hour above or below the posted speed limit, 15 miles per hour above or below the posted speed limit). In some implementations, the amount that the autonomous vehicle may operate above or below the posted speed limit may be included in map data used for navigation and operation of the autonomous vehicle (e.g., by an autonomous driving system on the autonomous vehicle, by an oversight system or remote computer controlling the autonomous vehicle). In some embodiments, the amount above or below the posted speed limit may be configurable based on local weather events, road conditions and topology, historical data describing speeds at which vehicles have been historically flagged for violation of the posted speed limit, or the like.

III.(b) Speed Control—Obey Speed Limits—Nighttime Speed

When driving after the sun has set, an autonomous vehicle may obey any nighttime specific speed limits. In some embodiments, nighttime specific speed limits may be indicated in map data that is provided to the autonomous vehicle and may be associated with a range of times. In some embodiments, nighttime specific speed limits are indicated by road signs present in the environment exterior to the autonomous vehicle, and the autonomous vehicle determines the nighttime specific speed limits for a roadway on which the autonomous vehicle is operating based on detecting the road signs. In some implementations, nighttime speed limits may be included in map data used for navigation and operation of the autonomous vehicle (e.g., by an autonomous driving system on the autonomous vehicle, by an oversight system or remote computer controlling the autonomous vehicle).

III.(c) Speed Control—Obey Contract Speed Limit

At all times, an autonomous vehicle may drive at or below any contract speed limits that are in place.

A contract speed limit is a limit that is set on the autonomous vehicle system's maximum speed, typically dictated by the terms of a contract with a partner or agreed upon by a set of stakeholders. For example, a partner or stakeholder that may be a company or entity that is associated with ownership of cargo being transported by the autonomous vehicle may indicate a contract speed limit based on the cargo.

III.(d) Speed Adjustments for Control of Autonomous Vehicle

An autonomous vehicle may maintain the posted speed limit (or less) with a reduction from the current speed as needed for control. For example, when the autonomous driving system determines that the weather or road conditions do not permit the autonomous vehicle to operate at the posted speed limit because the autonomous vehicle would be in danger of losing control or not having a sufficient distance between it and a NPC vehicle (e.g., a surrounding vehicle, including a manually operated vehicle or another autonomous vehicle that is not in direct communication with the autonomous vehicle) ahead, then the current speed of the autonomous vehicle may be reduced from the posted speed limit. The conditions which may warrant speed adjustments may be confirmed or justified by an oversight system, including by a remote control operator associated with an oversight system. Additionally, or alternatively, other autonomous vehicles along the same route or in adjacent locations may provide information which informs the determination that speed adjustment is warranted.

III.(e) Detect All Speed Limit Signs

An autonomous vehicle may be able to detect and classify all speed limit signs, including signs on local roads, highways, construction zones, and entry and exit ramps. This detection and classification may be done by the autonomous vehicle using data acquired by the suite of sensors aboard the autonomous vehicle, as well as computing modules on the autonomous vehicles configured to identify speed limit signs based on any of: sign color, overall sign shape, and the reading of icons or words on the sign. Alternatively, or additionally, a map or map database may have areas of changing speed limit identified, or areas of construction or other types of temporary speed limit changes identified, and the autonomous driving system may be more alert in those areas to evaluate signs for speed limit postings.

III.(f) Increase in Speed Limit—Max Acceleration

When approaching an increase in the speed limit, an autonomous vehicle may proactively speed up to the targeted speed using an acceleration rate under a pre-determined threshold value. The pre-determined threshold value for an acceleration rate may optimize for best fuel efficiency, unless the autonomous vehicle is behind schedule and needs to prioritize route arrival performance.

In some implementations, an oversight system, including a remote control operator associated with an oversight system, may provide guidance when greater acceleration is needed.

III.(g) Limit Acceleration and Deceleration as Needed for Control

Under all speed adjustments, an autonomous vehicle may set limits on the acceleration and deceleration to ensure the tractor and trailer do not destabilize and tip over, sway, or slip. The autonomous vehicle may determine orientation of itself using sensors including one or more inertial measurement unit (IMU), data obtained by cameras and other sensor, and the like to determine not only the current orientation of the autonomous vehicle, but also so predict possible changes to the orientation of the autonomous vehicle based on a possible loss of control due to changes in the speed of the autonomous vehicle.

III.(h) Decrease in Speed Limit—Engine Braking Preferred

When approaching a decrease in the speed limit, an autonomous vehicle may proactively slow down to the targeted speed using engine braking only, unless additional deceleration is required for an evasive maneuver. Engine braking may be accomplished in an autonomous vehicle with an internal combustion engine by employing any of: J-brakes (i.e., Jakes brakes), cylinder deactivation, or down-shifting of gears in the transmission.

III.(i) Uphill Grade—Power Adjustment under Load

When going uphill, an autonomous vehicle may provide additional power as necessary to maintain the targeted speed under different trailer loads.

III.(j) Precautionary Slow Down—T Intersection

When traveling in the through lane directly perpendicular to the non-through lane of a T-intersection, an autonomous vehicle may have a precautionary slow down (e.g., using engine braking) of no more than a pre-determined number of mph under the speed limit, such as 5 mph under the speed limit, 10 mph under the speed limit, 15 mph under the speed limit, and including 20 mph under the speed limit, if there is a vehicle stopped or approaching in the non-through lane.

III.(k) Curved Roads and Turns—Post-Apex Behavior

When on a curved road or intersection turn, an autonomous vehicle may speed up after passing the apex of the curve/turn with a ramp up value to ensure smooth acceleration and deceleration.

III.(l) Precautionary Slow Down—Signalized Intersection

When approaching a signalized intersection, an autonomous vehicle may have a precautionary slow down starting a pre-determined distance before the intersection, such as 90 meters away from the intersection, 100 meters away from the intersection, 110 meters from the intersection, including 120 meters from the intersection.

An autonomous vehicle may have a max passing speed equal to the posted speed limit or up to 50 mph at the pre-determined distance away from the intersection.

III.(m) Map—Update Speed Limits

The map used by the autonomous vehicle may update the speed limit information when new speed limit signs or speed limit signs with updated limits are encountered by the autonomous vehicle. In some embodiments, the map used by the autonomous vehicle may be stored locally at the autonomous vehicle. In some embodiments, the autonomous vehicle causes update of the map based on new speed limit sign encounters or speed limit discrepancies when the map is remotely stored (e.g., at an oversight system). For example, the autonomous vehicle transmits an indication of a new speed limit, an updated speed limit, or a speed limit discrepant with the map information to a remote computer of the oversight system. In some instances, updates to map information, including changes to the speed limit, may be provided by another autonomous vehicle that is in communication with the autonomous vehicle. Other autonomous vehicles, such as autonomous vehicles in a fleet, may communicate directly (e.g., V2V) or via an oversight system (e.g., V2C2V) or through another structure or means (e.g., data storage points, V2X2V).

III.(n) Map—Speed Limit Info

The map used by an autonomous vehicle may contain speed limit information for all mapped routes.

III.(o) Engine Braking for Efficiency

An autonomous vehicle may prefer to use engine braking when slowing as part of seeking a gap to lane change into for efficiency lane change intentions or intentions of lower priority.

III.(p) Downhill Grade—Engine Braking Preferred

When going downhill and deceleration is necessary, an autonomous vehicle may prefer to use engine braking. For a vehicle with an internal combustion engine, engine braking may include changing to a lower gear of the transmission (e.g., one with a smaller diameter than the current gear), generating backpressure or a vacuum in the engine, or selectively decompressing one or more cylinders of the engine during a combustion stroke. A motor in an electrical vehicle, an autonomous vehicle that has battery or fuel-cell powered motor(s), may achieve engine braking by depowering the motor(s) and/or changing gears (if available).

III.(q) Curved Roads and Turns—Pre-Apex Behavior

When approaching or on a curved road or intersection turn, autonomous vehicle may slow down, preferably using engine braking, before reaching the apex of the curve with a ramp up value that ensures smooth acceleration and deceleration.

III.(r) Speed Control—Obey Speed Limits—Ramps

An autonomous vehicle may obey any speed limits that are posted on an on-ramp or off-ramp when merging on or off a highway. In some embodiments, the autonomous vehicle may detect a road sign and determine, based on information indicated by the road sign, whether the road sign indicates a speed limit specific to an on-ramp or an off-ramp (e.g., as opposed to lanes of the highway).

III.(s) Speed Limit Sign Road Association

An autonomous vehicle may associate speed limit signs to the correct road structure (e.g., ramp speed limits vs highway speed limits). For example, a speed limit sign that is on an off-ramp, but still visible from the highway, may be associated with the ramp and not the highway. For example, a road sign associated with an on-ramp or an off-ramp may include text such as RAMP, EXIT, or the like, and the autonomous vehicle may detect and interpret text on a road sign. In other examples, a road sign may include directional indicators (e.g., arrows) indicating a particular road segment or structure to which the road sign corresponds. In other examples, the autonomous vehicle may identify the corresponding road segment for a road sign based on a location of the road sign. For example, the road sign may be located between a main segment of the roadway and an off-ramp, and based on the road sign being located closer to the ramp than to the main segment of the roadway, the autonomous vehicle may identify the ramp as being associated with the road sign. As another example, the road sign may be located on a side of a ramp opposite of a main segment of the roadway (thus being far removed from the main segment of the roadway), and the autonomous vehicle may identify the off-ramp as being associated with the road sign.

III.(t) Oversight—Update Speed Limits

When new speed limit signs or speed limit signs with updated limits are encountered, an autonomous vehicle may communicate the information to an oversight system, including to a remote control operator associated with the oversight system, which may be responsible for communicating the updated speed limit information to the rest of the fleet. In some embodiments, the autonomous vehicle may compare a detected speed limit and a speed limit that is indicated in map data, and if a discrepancy is identified, the autonomous vehicle may indicate the discrepancy to the oversight system.

III.(u) Speed Control—Speed Limit Timing

An autonomous vehicle may be at or below the speed limit by the time the frontmost point of the autonomous vehicle combination reaches the speed limit sign. The timing of when an autonomous vehicle reaches the speed limit posted on a roadside sign may depend on the regulation of the jurisdiction in which the sign is located.

III.(v) Engine Braking for Following Distance

An autonomous vehicle may prefer to use engine braking when growing or maintaining a following distance gap to another vehicle. For an internal combustion engine, engine braking may include use of a compression release engine braking mechanism configured for decompression of select cylinders, as well as switching to a lower gear. For electric motor autonomous vehicles, energy or power may be reduced to one or more motors powering the wheels of the autonomous vehicle.

III.(w) Speed Control When Approaching Signalized Intersections

When approaching a local signalized intersection, an autonomous vehicle may reduce its speed based a max speed equal to the posted speed limit or up to 50 mph. An autonomous vehicle may reach the target speed at least a pre-determined distance before the intersection, such as 90 meters away from the intersection, 100 meters away from the intersection, 110 meters from the intersection, including 120 meters prior to the stop line of the intersection, as measured from autonomous vehicle's front bumper to the stop line.

An autonomous vehicle may prefer to use engine braking or coasting to accomplish the required deceleration.

### IV. Hills

IV.(a) Hilly Road Description

Hilly roads may be defined as roads with a gradient of more than a pre-determined amount (e.g., 2%, 3%, 5%, 6%, etc.). In some embodiments, the pre-determined amount may be based on gradients that are expected to impact driving operation of a vehicle, such as gradients expected to cause acceleration, deceleration, loss of control, or the like of a vehicle in the absence of handling operations of the vehicle.

IV.(b) Brake Control

An autonomous vehicle may prioritize the usage of engine brakes over foundation brakes (e.g., disk brakes, drum brakes at each axel or each wheel) to preserve the effectiveness of foundation brakes and to prevent over heating of the foundation brakes.

IV.(c) Hilly Road Detection

An autonomous vehicle may be able to detect when the autonomous vehicle is driving on hilly roads based on the gradient using onboard sensors. These sensors may include: IMUs, gyroscopes, accelerometers, tilt sensors, gradient meters, and the like. Sensor data collected by the onboard sensors may be used to measure or estimate the gradient, in some embodiments. Alternatively, or additionally, information regarding the change of road gradient may be marked on a map utilized by the autonomous vehicle, and the location of the autonomous vehicle in conjunction with the mapping data may confirm the detection of changes of vehicle orientation corresponding to a road gradient.

IV.(d) Runaway Ramps

In the event of brake fade or failure, an autonomous vehicle may slow down and stop using a runaway ramp. Runaway ramps may be present beside sections of roadway with grades or slopes that are particularly steep. Runaway ramps that the autonomous vehicle may be configured to utilize any one or more of: arrester bed ramps, gravity slope ramps, sand pile escape ramps, or mechanical arrester escape ramps, each of which configured to cause deceleration of a vehicle entering and moving within a runaway ramp. An autonomous vehicle may be configured to utilize ramps that include the use of barriers, with the barriers configured to cause deceleration of the vehicle.

IV.(e) Hilly Road Sign Recognition

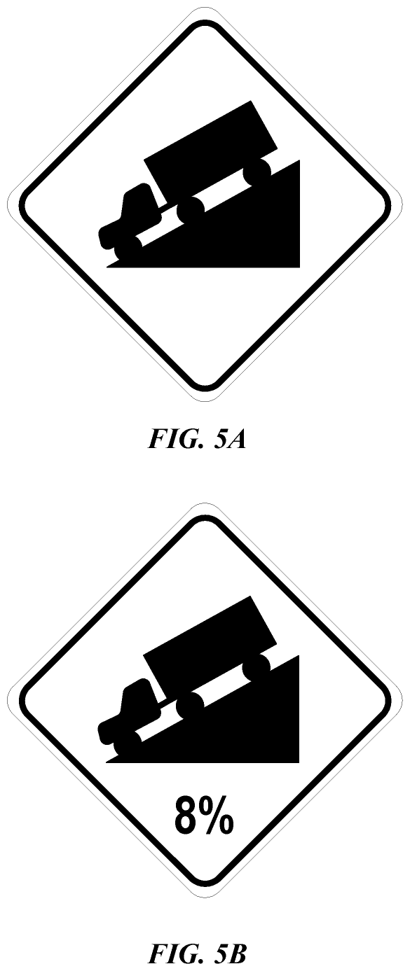

An autonomous vehicle may be able to recognize signs that indicate hilly roads. FIGS. 5A and 5B illustrate example road signs that indicate hilly roads, or roadways that have an uphill or downhill grade that is significant enough to potentially impact driving operation. Some example road signs, including the example road sign illustrated in FIG. 5B, may specifically indicate a percent grade of an associated roadway, and in some embodiments, the autonomous vehicle may obtain grade information of a roadway based on such indications by a road sign.

IV.(f) Engine Brake Prohibition

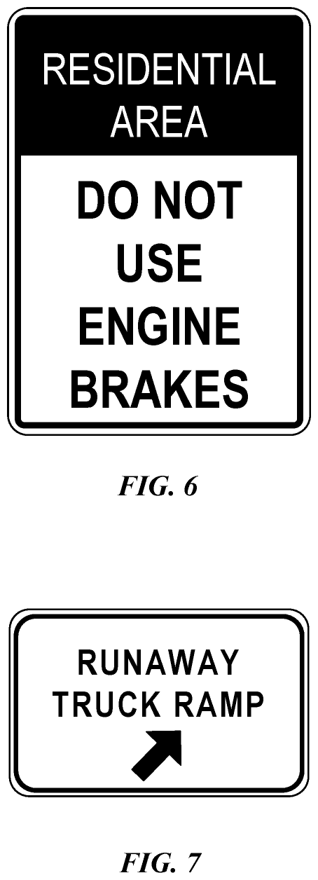

If a “NO ENGINE BRAKE” sign is encountered, an autonomous vehicle may not engage engine brakes for a minimum of a pre-determined threshold distance. FIG. 6 illustrates an example road sign that indicates a prohibition of engine braking on an associated roadway. Generally, “No Engine Brake” zones apply to internal combustion engine vehicle that utilize compression release engine braking mechanisms (or decompression brake mechanisms) that depressurize engine cylinders in coordination with a combustion strokes. Such compression release engine braking mechanisms depower the engine through the depressurization, although also cause loud sounds. In some examples, these loud sounds can be the reason for the “No Engine Brake” zone.

IV.(g) Lane Change Avoidance

An autonomous vehicle may avoid all types of efficiency and lower priority lane changes when driving on hilly roads.

IV.(h) Speed Control

An autonomous vehicle may select an appropriate speed when driving on hilly roads to prevent the tipping, swaying or slipping of the trailer. In some embodiments, the appropriate speed selected may be within a predetermined range of speeds that is based on the gradient of the hilly road.

An autonomous vehicle may consider the steepness of the gradient, the curvature of the road, the road traction condition, the prevailing weather condition, visibility condition as well as the weight and center of gravity of autonomous vehicle and the trailer.

IV.(i) Contact Operator

If autonomous vehicle is in the runaway ramp and has come to a stop, autonomous vehicle may remain stationary and contact an operator, such as a remote control operator (RCO) associated with an oversight system or control center for one or more autonomous vehicles. The oversight system or control center may in turn communicate with one or more service systems or entities to arrange for service of the stopped autonomous vehicle, arrange for a tow truck to be sent, and/or arrange for alternative equipment to be sent to the stopped autonomous vehicle so that delivery of the cargo may be completed.

IV.(j) Occupied Runaway Ramps

When a runaway ramp is occupied by another vehicle, an autonomous vehicle may still use the runaway ramp but bias to avoid the vehicle that is already on the runaway ramp.

IV.(k) Mapping

An autonomous vehicle may have hilly roads and known runaway ramps mapped out for navigation use. In some embodiments, the autonomous vehicle receives map data (e.g., from an oversight system) that identifies segments or portions of roadways that are hilly (e.g., having a gradient greater than a predetermined threshold) or that are runaway ramps.

IV.(l) Rolling Backwards

An autonomous vehicle may avoid rolling backwards when stopped or starting from a stop on a hilly road. This may be accomplished by engaging a parking break or steering the autonomous vehicle so that the wheels are angled to prevent vehicle motion. Alternatively, or additionally, the autonomous vehicle may steer to a flat area (as determined by the sensors on the vehicle).

IV.(m) Runaway Ramp Identification

An autonomous vehicle may be able to identify runaway ramps based on pre-mapped locations and road signs. FIG. 7 illustrates an example road sign that identifies a runaway ramp. As illustrated, example road signs that identify a runaway ramp may include a directional indicator (e.g., an arrow) that clearly indicates a portion of a roadway that is the runaway ramp, and in some embodiments, the autonomous vehicle detects, via one or more sensors, and interprets such directional indicators to identify a runaway ramp in accordance with the road sign.

IV.(n) Right Lane Preference

An autonomous vehicle may drive on the right lane when on hilly roads unless for evasive maneuvers or avoiding ELVs (e.g., emergency lane vehicles or disabled vehicles).

IV.(o) Runaway Procedure

When an autonomous vehicle is unable to come to a stop due to brake fade or failure, the autonomous vehicle may engage maximum engine braking, turn the hazard lights on and use the horn to warn other road users. An autonomous vehicle may change lanes to the slowest lane adjacent to a shoulder lane (e.g., the rightmost lane in North American jurisdictions) at the first opportunity possible to enable the usage of a runaway ramp when available.

IV.(p) Hazard Lights

Unless in a traffic jam, an autonomous vehicle may turn on hazard lights on hilly roads if autonomous vehicle is driving more than a pre-determined threshold amount (e.g., 10, mph, 15 mph, 20 mph, 25 mph. 30 mph, etc.) below the speed limit or if autonomous vehicle is driving at a speed of less than a pre-determined threshold level (e.g., 35 mph, 40 mph, 45 mph, 50 mph, etc.).

### V. Highway Exits

The compliance module of the in-vehicle control computer of an autonomous vehicle can perform image processing on traffic signs to identify information indicated by the traffic sign as further explained in this section.

V.(a) Backed up Highway Exit

When a highway exit is backed up, an autonomous vehicle may be able to detect a line of NPCs (e.g., surrounding vehicles) in the exit lane and slow down to join at the end of the line.

V.(b) Backed Up Highway Exit Merge-In

When a highway exit is backed up and an autonomous vehicle was not able to join the line at the end, the autonomous vehicle may slow down to no slower than a pre-determined threshold amount below the average highway traffic speed to seek for a gap to merge in. If autonomous vehicle is unable to merge in, autonomous vehicle may use an alternative route that includes exiting the highway at a different highway exit. These actions may prevent the autonomous vehicle from causing secondary traffic incidents while exiting the highway.

V.(c) Stay in Exit Lane

An autonomous vehicle may keep in the exit lane for a minimum pre-determined distance before exit point. The minimum pre-determined distance before an exit point may be approximately 800 meters (0.5 miles), 1200 meters (0.75 miles), 1600 meters (1 mile), or 2000 meters (1.25 miles).

V.(d) Multi-Lane Exit

An autonomous vehicle in a multi-lane exit may choose to drive in a lane that is most appropriate for the next part of the journey after getting off of the off-ramp. For example, if there are two exit lanes, the autonomous vehicle may keep in the rightmost lane if turning right at the end of the exit ramp.

V.(e) Closed Exit

When an exit that an autonomous vehicle is intending to use is closed, the autonomous vehicle may rejoin the highway and use an alternative route that involves a different highway exit. In some embodiments, the autonomous vehicle may determine that the intended exit is closed based on detecting a road sign that indicates closure of the intended exit, one or more flashing emergency vehicles that are statically positioned in (and obstructing) the highway exit, or the like.

V.(f) Exit Zone—Description

The exit area may be defined as the area that starts with where the offramp lane start to split away from the highway and ends with the separation of the offramp from the highway by the means of a solid line, gore area, hard or soft shoulders.

V.(g) Alternative Route

An autonomous vehicle may have alternative routes mapped as a backup for all highway exits to ensure that autonomous vehicle will eventually arrive at the destination. For example, an alternative route may include exiting the highway and reentering the highway at a different location to go back to the intended exit. Additionally, or alternatively, alternate routes may be determined to utilize access roads or surface streets to follow a route that eventually merges with the original, intended route to the ultimate destination.

V.(h) Dedicated Exit Lane

When a dedicated exit lane is available for the exit, an autonomous vehicle may change lanes to the exit lane at the first opportunity possible.

V.(i) Highway Exit in Traffic Jam

In a traffic jam, an autonomous vehicle may identify and enter the exit lane by creating gaps in order to merge into the exit lane. Gap creation may include using signal lights to communicate intent to other vehicles (e.g., NPCs), as well as by slowing down in the current lane of travel to wait for a gap to appear or grow.

V.(j) Mapping

An autonomous vehicle may have highway exits and alternative routes identified and mapped in the navigation maps. These maps may be updated based on detection and image processing of signage or road advisories informing of planned exit closures. Planned temporary exit closures may be included on navigation maps.

V.(k) Exit Area

An autonomous vehicle may be able to identify the exit area of the highway in order to determine where to exit. This may include identifying changes in lane markings, detection and identification of signage, identification of gore areas, and the like.

V.(l) Exit Sign Recognition

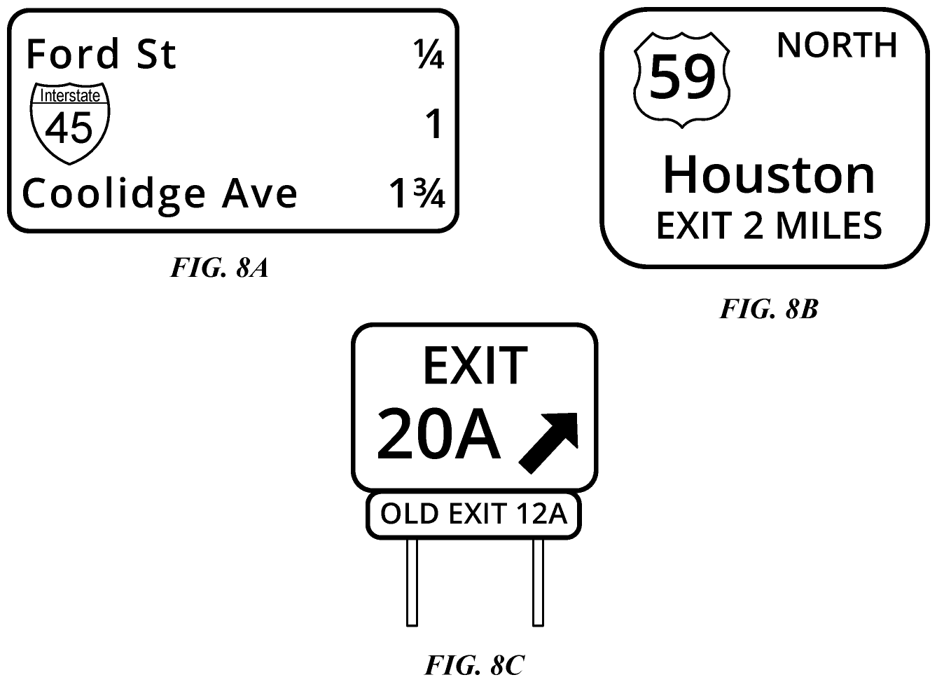

An autonomous vehicle may be able to recognize highway exits based on the signs. FIGS. 8A, 8B, and 8C illustrate example road signs that indicate highway exits. In some examples, such as the road sign illustrated in FIGS. 8A and 8B, a road sign may indicate one or more highway exits and a corresponding distance to each highway exit. The autonomous vehicle may accordingly determine the distance to a highway exit based on a road sign.

In some examples, such as the road sign illustrated in FIG. 8C, a road sign may include a reference identifier or a reference numeral that is uniquely associated with a highway exit. In some embodiments, route information provided to and used by the autonomous vehicle may indicate a particular highway exit via the reference identifier or numeral, and the autonomous vehicle may detect the particular highway exit based on a road sign that includes the reference identifier or numeral.

Using route information provided to the autonomous vehicle and information detected via highway exit road signs, an autonomous vehicle may determine a trajectory to reach the highway exit indicated by the detected highway exit road signs.

V.(m) K-ramp exit

An autonomous vehicle may seek gaps when taking a K-ramp highway exit. If autonomous vehicle is unable to exit due to insufficient gap, autonomous vehicle may use an alternative route.

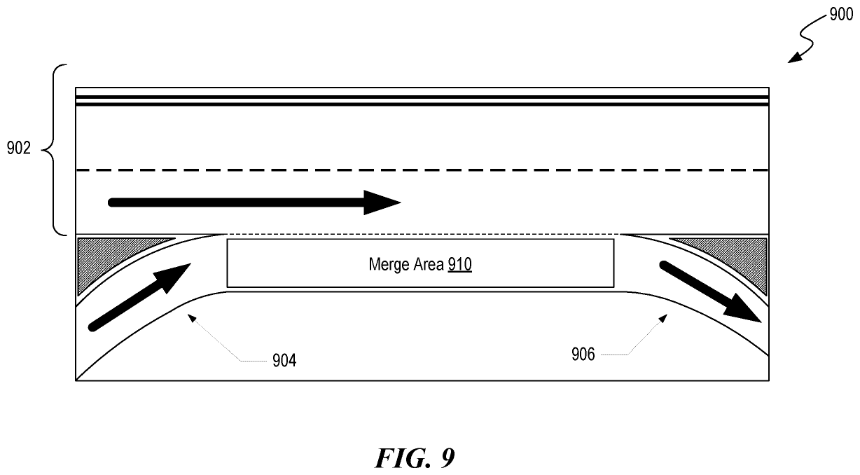

In some examples, a K-ramp portion of a roadway may be associated with relatively high merging traffic. FIG. 9 shows a diagram illustrating an example K-ramp at which some vehicles attempt to merge onto a main portion of the roadway and via which other vehicles attempt to exit the main portion of the roadway. In FIG. 9, bolded black arrows represent a direction of travel. As shown, a K-ramp 900 may generally include two ramps, including an on-ramp 904 and an off-ramp 906, connected to a main portion 902 of the roadway and via which vehicles can merge onto the main portion 902 (via the on-ramp 904) and exit off of the main portion 902 (via the off-ramp 906). The two ramps form a “k” shape with the main portion 902 of the roadway. Indeed, the two ramps connect with the main portion 902 of the roadway at a merge area 910, which can be seen as the vertex of the “k” shape. Such K-ramps may appear in various roadway interchanges of different configurations, such as cloverleaf interchanges. A K-ramp is further distinct due to, in a direction of travel, tight turning merging traffic occurring first followed by tight turning exiting traffic. In contrast, other ramp configurations for a roadway may, in a direction of travel, have a relatively straight off-ramp for exiting traffic first before a relatively straight on-ramp for merging traffic.

Accordingly, to operate with a K-ramp, an autonomous vehicle may identify and navigate to gaps between vehicles in a merge area 910 of a K-ramp portion of a roadway. A merge area 910 may be defined in map data associated with the K-ramp. In doing so, the autonomous vehicle may detect and predict trajectories for vehicles on the on-ramp portion of the K-ramp that are attempting to merge onto the main portion of the roadway.

V.(n) Off-ramp Speed Limit

An autonomous vehicle may drive at a speed that is below the off-ramp speed limit for the entirety of the off-ramp. The degree to which an autonomous vehicle drives below the posted off-ramp speed limit may depend on the geometry of the off-ramp, the loading of cargo in the autonomous vehicle, the type of autonomous vehicle configuration, the road conditions, wind conditions, precipitation, visibility, and the like.

V.(o) Speed Reduction

An autonomous vehicle may slow down to a safe speed for the off ramp before taking the highway exit and avoid heavy deceleration of more than a pre-determined threshold value to prevent tipping and swaying of the trailer. Additionally the autonomous vehicle may speed up at the apex of an off-ramp if the off-ramp is a curved ramp or a banked ramp.

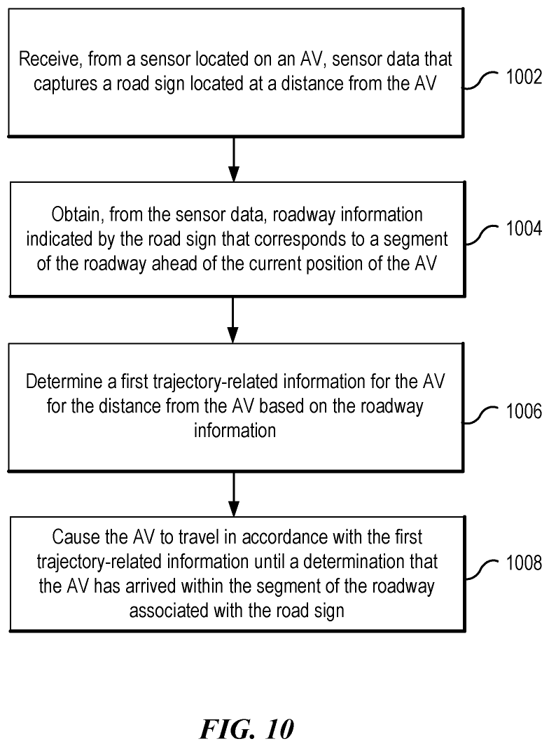

FIG. 10 shows an example flowchart for operating an autonomous vehicle in accordance with various embodiments described herein. In particular, FIG. 10 illustrates example operations for operating an autonomous vehicle along segments of a roadway that correspond to detected road signs. Thus, with the example operations illustrated in FIG. 10, safe and compliant operation of an autonomous vehicle can be enabled, and various technical benefits are provided.

At operation 1002, sensor data is received. The sensor data is received from a sensor located on the autonomous vehicle and captures a road sign located at a distance from the autonomous vehicle.

At operation 1004, roadway information indicated by the road sign is obtained from the sensor data. The roadway information corresponds to a segment of the roadway associated with the road sign. The segment of the roadway is ahead of a current position of the autonomous vehicle on the roadway. In various examples, the segment of the roadway that is associated with the road sign may include a highway on-ramp, a highway off-ramp, a runaway ramp, a merge area of a K-ramp, or a distance along a main portion of the roadway.

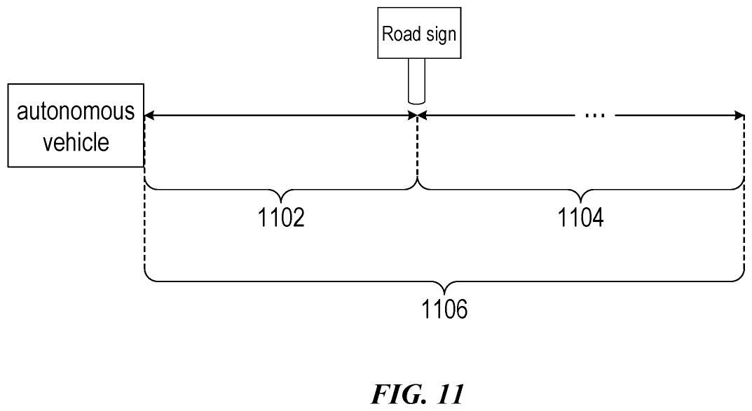

FIG. 11 shows a diagram that illustrates an example scenario involving an autonomous vehicle and a road sign. As illustrated, the road sign is located at a first distance 1102 from the autonomous vehicle at a given point in time. It may be understood that the first distance 1102 decreases as the autonomous vehicle approaches the road sign, and detection of the road sign may occur while the first distance 1102 is within a sensor range of the sensor located on the autonomous vehicle. The road sign is associated with a roadway segment 1104, and in some examples, the roadway segment 1104 is located after or behind the road sign in the direction of travel. In some examples, the roadway segment 1104 may begin at a location of the road sign, as illustrated. In other examples, the roadway segment 1104 may begin at a location past the road sign; for example, the roadway segment 1104 may be a highway exit ramp whose location is indicated by the road sign. In some embodiments, the roadway segment 1104 associated with the road sign may be an open segment, spanning to an unknown point on the roadway. Accordingly, the autonomous vehicle may continue to determine that the autonomous vehicle is located within the roadway segment 1104 for an indefinite amount of time until a stopping condition, which may include exiting the roadway completely or detecting another road sign and/or entering a different roadway segment associated with a different road sign.

Returning to FIG. 10, at operation 1006, a first trajectory-related information for the autonomous vehicle is determined. The first trajectory-related information for the autonomous vehicle is for the distance from the autonomous vehicle at which the road sign is located (e.g., the first distance 1102 in FIG. 11) and is based on the roadway information obtained from the sensor data.

At operation 1008, the autonomous vehicle is caused to travel in accordance with the first trajectory-related information until a determination that the autonomous vehicle has arrived within the segment of the roadway associated with the road sign. Thus, for example, the first trajectory-related information may preemptively control operation of the autonomous vehicle such that, upon entering the segment of the roadway, the autonomous vehicle is prepared to operate in accordance with certain constraints, properties, or behaviors associated with the segment as indicated by the road sign.

In some embodiments, the roadway information obtained from the sensor data includes a speed limit for the segment of the roadway (e.g., roadway segment 1104), and the first trajectory-related information includes an acceleration or a deceleration of the autonomous vehicle based on a difference between the speed limit and a speed of the autonomous vehicle. Accordingly, the autonomous vehicle is operated before being located within the segment of the roadway such that, upon arriving within the segment of the roadway, the autonomous vehicle is travelling at a certain speed. In some embodiments, the first trajectory-related information includes an acceleration based on the speed limit being greater than a speed of the autonomous vehicle. In some embodiments, the first trajectory-related information includes a deceleration based on the speed limit being lower than a speed of the autonomous vehicle. In some embodiments, the method of operating the autonomous vehicle further includes determining a second trajectory-related information for the autonomous vehicle that is specific to the segment of the roadway and that satisfies the speed limit of the roadway information (e.g., having a speed within a predetermined number above or below the speed limit), and causing the autonomous vehicle to travel in accordance with the second trajectory-related information subsequent to the determination that the autonomous vehicle has arrived within the segment of the roadway associated with the road sign.

In some embodiments, the method of operating the autonomous vehicle includes further operations including comparing the roadway information obtained from the sensor data with stored map information that is associated with the segment of the roadway, and responsive to a determination of a discrepancy between the roadway information and the stored map information, transmitting an indication of the discrepancy to a remote computer located at a remote location outside of the autonomous vehicle or updating the stored map information based on the roadway information obtained from the sensor data.

In some embodiments, the method of operating the autonomous vehicle further includes identifying the segment of the roadway associated with the road sign based on the sensor data, the sensor data indicating a relative location of the road sign relative to one or more segments of the roadway. In some embodiments, the segment of the roadway is identified based on the sensor data capturing a text-based indication of the segment of the roadway from the road sign. For example, the segment of the roadway may be a highway exit, and the road sign may include an indication of a name or identifier for the highway exit as well as a location of the highway exit.

In some embodiments, the roadway information indicated by the road sign indicates a presence of a gradient for the segment of the roadway that is greater than a predetermined amount. In some embodiments, the method of operating the autonomous vehicle further includes, based on the determination that the autonomous vehicle is located within the segment of the roadway associated with the road sign, measuring the gradient of the segment of the roadway using one or more sensors located on the autonomous vehicle. In some embodiments, the roadway information indicated by the road sign indicates a gradient measure for the segment of the roadway. In some embodiments, the gradient measure indicates a downhill gradient, and the method further includes, based on the determination that the autonomous vehicle has arrived within the segment of the roadway associated with the road sign, transmitting braking instructions to one or more devices located on the autonomous vehicle. In some embodiments, the braking instructions are configured to cause engine braking of the autonomous vehicle, and the one or more devices may include devices configured for compression release engine braking, decompression braking, depressurization braking, or the like.

In some embodiments, the segment of the roadway that is associated with the road sign is a highway exit, and the roadway information indicated by the road sign indicates a distance from the road sign to the highway exit. In some embodiments, the first trajectory-related information is determined based on detecting one or more vehicles operating on the roadway that are expected to travel through the highway exit. In some embodiments, the roadway information includes a unique identifier associated with the highway exit, and the first trajectory-related information is configured to cause the autonomous vehicle to travel to the segment of the roadway based on the unique identifier being indicated in route information provided to the autonomous vehicle.

### VI. Going Straight Through Intersections

VI.(a) Lane Selection

An autonomous vehicle may identify and select the lane to cross straight through an intersection based on the lane from which the autonomous vehicle initiated the intersection crossing.

VI.(b) Traffic Light Occlusion

If the traffic light is occluded, autonomous vehicle may stop before the intersection and then creep forward to get a better view of the traffic light. If the traffic light is still occluded, autonomous vehicle may treat this intersection as an unprotected time-to-collision (TTC) stop. A time-to-collision stop may involve determining whether there is sufficient time to cross through an intersection without colliding with cross-traffic or a vehicle turning in the intersection.

VI.(c) Cross-Traffic Condition

An autonomous vehicle may consider the cross-traffic condition and yield for non-compliant cross traffic vehicles that are not stopping.

VI.(d) Malfunctioning Traffic Light—Stop Sign

An autonomous vehicle may treat the intersection as a stop sign intersection if the traffic lights are off or flashing red.

VI.(e) Hard Deceleration Avoidance

An autonomous vehicle may avoid a hard deceleration of more than a pre-determined threshold value when braking for a yellow light. The pre-determined threshold deceleration value may be no more than 3.8 m/s\hat{ }2, no more than 3.4 m/s\hat{ }2, such as no more than 3.0 m/s\hat{ }3, including no more than 2.5 m/s\hat{ }2.

If at the time when the traffic light turns yellow and autonomous vehicle determines that autonomous vehicle will need a deceleration of more than a pre-determined threshold value in order to stop before the intersection, autonomous vehicle may accelerate enough to cross the intersection and ensure that part of autonomous vehicle is already in the intersection before the yellow light interval ends instead. In some embodiments, the autonomous vehicle may operate accordingly to cross the intersection based on map data that indicates that the intersection is located within a jurisdiction that permits intersection travel during a yellow traffic light without penalty. For example, the map data for an intersection may include a flag that controls yellow crossing operation of the autonomous vehicle.

VI.(f) Lane Change Avoidance

An autonomous vehicle may avoid lane changes when autonomous vehicle is within in an intersection unless for an evasive maneuver. For example, when an autonomous vehicle is crossing an intersection or turning into an intersection, the autonomous vehicle will maintain its course of travel, including the lane in which it is traveling, unless evasive maneuvers are needed to avoid a collision or other undesirable situation.

VI.(g) Traffic Light Detection

An autonomous vehicle may be able to identify traffic lights and determine when the traffic light signal for autonomous vehicle's path of travel indicates that the autonomous vehicle is allowed to cross the intersection.

VI.(h) Malfunctioning Traffic Light—Yield

When an autonomous vehicle encounters a malfunctioning traffic light that is flashing amber (or yellow, depending on the jurisdiction), the autonomous vehicle may avoid stopping, but instead slow down and yield for NPCs already in the intersection, as appropriate according to local regulations. In some jurisdictions, when a traffic light is flashing red, the autonomous vehicle may treat the intersection as a four-way stop and operate as if the traffic light was a stop sign. In some instances, an autonomous vehicle may identify a flashing traffic light based on observing (e.g., collecting sensor data on) a traffic light for a time period.

VI.(i) Intersection Blockage

An autonomous vehicle may avoid entering the intersection if the portion of the intersection that autonomous vehicle is going to cross is still occupied by traffic.

VI.(j) Yellow Light Behavior

If the traffic light turned yellow in an intersection before an autonomous vehicle has arrived at the intersection, the autonomous vehicle may determine if the autonomous vehicle is able to cross the intersection based on the time taken to arrive and cross the intersection.

VI.(k) Intersection Clearance Room

An autonomous vehicle may avoid entering the intersection if there is not sufficient room beyond the intersection for autonomous vehicle to completely clear the intersection. In some embodiments, the autonomous vehicle may use information that includes a length of the autonomous vehicle (and any trailing components, such as a trailer) to determine whether there is sufficient room for a rearmost point of the autonomous vehicle to completely clear the intersection.

VI.(l) Mapping

An autonomous vehicle may have intersections identified and mapped for navigation purposes. In some implementations, temporary closures of intersections or changes to traffic patterns around intersections may be provided periodically to the autonomous vehicle either by an oversight system over the air, by another autonomous vehicle over the air, or during routine service of the autonomous vehicle. Temporary closures or changes may be due to, for example, flooding or other weather conditions, construction, or a vehicle incident (e.g., collision).

VI.(m) Yellow Light Duration

If the yellow light duration is unknown, an autonomous vehicle may assume that the yellow light has a duration of a predetermined number of seconds. The predetermined number of seconds may be 2 or 3 seconds, for example.

VI.(n) Malfunctioning Traffic Light

If an autonomous vehicle detects that the lights at an intersection are not operating in a normal way, the autonomous vehicle may classify the traffic light as malfunctioning.

Types of malfunctioning traffic lights may include: (i) Flashing Red, (ii) Flashing Amber, and (iii) Traffic light powered off. In some embodiments, the autonomous vehicle transmits an indication of a malfunctioning traffic light to an oversight system, and the oversight system may provide information related to the malfunctioning traffic light to other autonomous vehicles.

VI.(o) Blocking Intersection

Autonomous vehicle may not enter an intersection when the autonomous vehicle predicts that it will not completely exit the intersection by the end of the red clearance interval. The red clearance interval may be defined as the amount of time between signal lights at an intersection turning from green to red in a first direction and including the time before turning from red to green in a second direction which crosses the first direction.

In order to perform the above features, an autonomous vehicle may utilize any of the sensors, particularly the data obtained from the sensors, in conjunction with the computing facilities on-board the autonomous vehicle, such as those associated with or in communication with the VCU. Alternatively, or additionally, the above features may be executed by an autonomous vehicle with aid from an oversight system, or control center, and optionally with aid from a human remote control operator. The oversight system, and in some cases the remote control operator, may communicate environmental data, map updates, instructions, or other information to an autonomous vehicle. An on-board map, such as a high-definition map, may be used by an autonomous vehicle to accomplish some of the features described herein, particularly when knowledge of location and local regulations (e.g., speed limits, obligations under the law, traffic conventions, intersection types) is needed to complete a task described in the feature.

While this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of characteristics that may be specific to particular embodiments or sections of particular inventions. Certain characteristics that are described in this patent document in the context of separate embodiments or sections can also be implemented in combination in a single embodiment or a single section. Conversely, various characteristics that are described in the context of a single embodiment or single section can also be implemented in multiple embodiments or multiple sections separately or in any suitable sub combination. A feature or operation described in one embodiment or one section can be combined with another feature or another operation from another embodiment or another section in any reasonable manner. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of operating an autonomous vehicle, comprising:
receiving, from a sensor located on the autonomous vehicle, sensor data that captures a road sign located at a distance from the autonomous vehicle that is operating on a roadway;
obtaining, from the sensor data, roadway information indicated by the road sign,
wherein the roadway information corresponds to a segment of the roadway associated with the road sign, and
wherein the segment is ahead of a current position of the autonomous vehicle on the roadway;
determining a first trajectory-related information for the autonomous vehicle for the distance, wherein the first trajectory-related information is based on the roadway information obtained from the sensor data; and
causing the autonomous vehicle to travel in accordance with the first trajectory-related information until a determination that the autonomous vehicle has arrived within the segment of the roadway associated with the road sign.

2. The method of claim 1, wherein the roadway information obtained from the sensor data includes a speed limit for the segment of the roadway, and wherein the first trajectory-related information includes an acceleration or a deceleration of the autonomous vehicle based on a difference between the speed limit and a speed of the autonomous vehicle.

3. The method of claim 2, further comprising:
determining a second trajectory-related information for the autonomous vehicle, wherein the second trajectory-related information is specific to the segment of the roadway, and wherein the second trajectory-related information satisfies the speed limit of the roadway information; and
causing the autonomous vehicle to travel in accordance with the second trajectory-related information subsequent to the determination that the autonomous vehicle has arrived within the segment of the roadway associated with the road sign.

4. The method of claim 1, further comprising:
comparing the roadway information obtained from the sensor data with stored map information that is associated with the segment of the roadway; and
responsive to a determination of a discrepancy between the roadway information and the stored map information, transmitting an indication of the discrepancy to a remote computer located at a remote location outside of the autonomous vehicle.

5. The method of claim 1, further comprising:
identifying the segment of the roadway associated with the road sign based on the sensor data, wherein the sensor data indicates a relative location of the road sign relative to one or more segments of the roadway.

6. The method of claim 5, wherein the one or more segments of the roadway include a highway on-ramp, a highway off-ramp, or a runaway ramp.

7. The method of claim 1, wherein the segment of the roadway that is associated with the road sign is a highway exit, and wherein the roadway information indicated by the road sign indicates a distance from the road sign to the highway exit.

8. The method of claim 7, wherein the first trajectory-related information is determined based on detecting one or more vehicles operating on the roadway that are expected to travel through the highway exit.

9. A system for operating an autonomous vehicle, comprising a computer that includes a processor and a memory storing instructions that, when executed by the processor, cause the system to:
receive, from a sensor located on the autonomous vehicle, sensor data that captures a road sign located at a distance from the autonomous vehicle that is operating on a roadway;
obtain, from the sensor data, roadway information indicated by the road sign,
wherein the roadway information corresponds to a segment of the roadway associated with the road sign, and
wherein the segment is ahead of a current position of the autonomous vehicle on the roadway;
determine a first trajectory-related information for the autonomous vehicle for the distance, wherein the first trajectory-related information is based on the roadway information obtained from the sensor data; and
cause the autonomous vehicle to travel in accordance with the first trajectory-related information until a determination that the autonomous vehicle has arrived within the segment of the roadway associated with the road sign.

10. The system of claim 9, wherein the roadway information obtained from the sensor data includes a speed limit for the segment of the roadway, and wherein the first trajectory-related information includes an acceleration of the autonomous vehicle based on the speed limit being greater than a speed of the autonomous vehicle.

11. The system of claim 9, wherein the instructions, when executed by the processor, further cause the system to:
compare the roadway information obtained from the sensor data with stored map information that is associated with the segment of the roadway; and
responsive to a determination of a discrepancy between the roadway information and the stored map information, update the stored map information based on the roadway information obtained from the sensor data.

12. The system of claim 9, wherein the instructions, when executed by the processor, further cause the system to:
identify the segment of the roadway associated with the road sign based on the sensor data capturing a text-based indication of the segment of the roadway from the road sign.

13. The system of claim 9, wherein the roadway information indicated by the road sign indicates a presence of a gradient for the segment of the roadway that is greater than a predetermined amount.

14. The system of claim 13, wherein the instructions, when executed by the processor, further cause the system to:
based on the determination that the autonomous vehicle is located within the segment of the roadway associated with the road sign, measure the gradient of the segment of the roadway using one or more sensors located on the autonomous vehicle.

15. The method of claim 1,
wherein the segment of the roadway that is associated with the road sign is a highway exit,
wherein the roadway information indicated by the road sign and obtained from the sensor includes a unique identifier associated with the highway exit, and
wherein the first trajectory-related information is configured to cause the autonomous vehicle to travel to the segment of the roadway based on the unique identifier being indicated in route information provided to the autonomous vehicle.

16. A non-transitory computer readable program storage medium having code stored thereon, the code, when executed by a processor, causing the processor to perform operations comprising:
receiving, from a sensor located on an autonomous vehicle, sensor data that captures a road sign located at a distance from the autonomous vehicle that is operating on a roadway;
obtaining, from the sensor data, roadway information indicated by the road sign,
wherein the roadway information corresponds to a segment of the roadway associated with the road sign, and
wherein the segment is ahead of a current position of the autonomous vehicle on the roadway;
determining a first trajectory-related information for the autonomous vehicle for the distance, wherein the first trajectory-related information is based on the roadway information obtained from the sensor data; and
causing the autonomous vehicle to travel in accordance with the first trajectory-related information until a determination that the autonomous vehicle has arrived within the segment of the roadway associated with the road sign.

17. The non-transitory computer readable program storage medium of claim 16, wherein the roadway information obtained from the sensor data includes a speed limit for the segment of the roadway, and wherein the first trajectory-related information includes a deceleration of the autonomous vehicle based on the speed limit being lower than a speed of the autonomous vehicle.

18. The non-transitory computer readable program storage medium of claim 16, wherein the roadway information indicated by the road sign indicates a gradient measure for the segment of the roadway.

19. The non-transitory computer readable program storage medium of claim 18, wherein the gradient measure indicates a downhill gradient, and wherein the operations further comprise:
based on the determination that the autonomous vehicle has arrived within the segment of the roadway associated with the road sign, transmitting braking instructions to one or more devices located on the autonomous vehicle.

20. The non-transitory computer readable program storage medium of claim 19, wherein the braking instructions are configured to cause engine braking of the autonomous vehicle.
